(19) United States
(12) Patent Application Publication
(10) Pub. No.: US 2014/0070551 A1
(43) Pub. Date: Mar. 13, 2014

(54) Rear Lift Gate Window Ventilation Swing-Arm Assembly

(71) Applicant: Albert Waibun LI, Danville, CA (US)

(72) Inventor: Albert Waibun LI, Danville, CA (US)

(21) Appl. No.: 13/612,649

(22) Filed: Sep. 12, 2012

(51) Int. Cl. E05C 17/02

(52) U.S. Cl. CPC E05C 17/02
USPC 292/338; 164/47; 72/362; 72/253.1; 29/592; 29/557

(57) ABSTRACT

The rear lift gate swing arm ventilation assembly is for most vehicles, domestic or foreign, equipped with rear swing out window in the rear lift gate. The assembly provides improved air circulation by allowing the rear window open at a pre-set width. The swing arm acts as an extended strike loop when attached to the factory rear window loop. The assembly comprises of a “U” shaped round metal rod and a rectangle shaped metal base. The free ends of the “U” shaped rod provide a rectangle flange with bores for bolts to pass through. The metal base comprises of two rectangle metal blocks, one block with two bores with internal threads in both ends; both blocks provide a central vertical bore with internal threads. The metal base provide two bores along the longitudinal axis, to dimension as set in factory strike loop. The brackets wrap over the factory window's strike loop and secure by the central vertical bolt.

### BACKGROUND

Most sport utility vehicles and wagons, domestic or foreign, equipped with a rear lift gate with a window, that the window is hinged on the top which allow it to swing open. The factory rear window was designed to swing open all the way up, or fully closed. There is no provision to leave the window open at a pre-determined position

With the rear lift gate window ventilation swing-arm assembly, the ability to increase air circulation by propping this window open several inches will benefit air movement within the cabin.

The Rear Lift Gate Window Ventilation Swing-Arm assembly is essentially an extension of the factor rear window strike loop. When properly installed onto the factory window strike loop, it will allow the window to remain open at a preset width, this width is determined by the length of the swing arm.

When the swing arm assembly is properly latched into the factory locking mechanism, the swing arm assembly will stabilize the rear window in the opened position. When the vehicle's doors are closed and locked, the swing arm assembly will also be locked in the factory lock assembly, thus preventing unwanted opening of the window when the release button is depressed outside the door.

When venting of cabin is no longer desired, the swing arm assembly rotates up and remains in the upright position, allowing the factory strike loop to be used. The swing arm assembly, when installed properly, will not interfere with the normal operation of the factory latching mechanism, as the swing arm brackets will clear the lift gate interior plastic trim pieces.

### BRIEF DESCRIPTION OF THE DRAWINGS

FIG. 1 is a front view of the present bracket assembly, with the upper bracket positioned on the right having internal threads in both ends. The lower bracket having one central bore with internal threads.

FIG. 2 is a side view of the present bracket assembly.

FIG. 3 is a front view of the present swing arm assembly.

FIG. 4 is a side view of the present swing arm assembly.

FIG. 5 is an exploded perspective of the present rear lift gate window ventilation swing arm assembly.

FIG. 6 is a front view of the present bracket assembly with markings for two 9/32″ bores, along the centerline.

FIG. 7 is the top view of the present upper and lower bracket. The upper bracket to provide a 9/32″ bore, and the lower bracket to provide a ¼″ bore to receive internal threads.

FIG. 8 is the end view of the present upper bracket with marking to provide a ¼″ bore to receive internal threads.

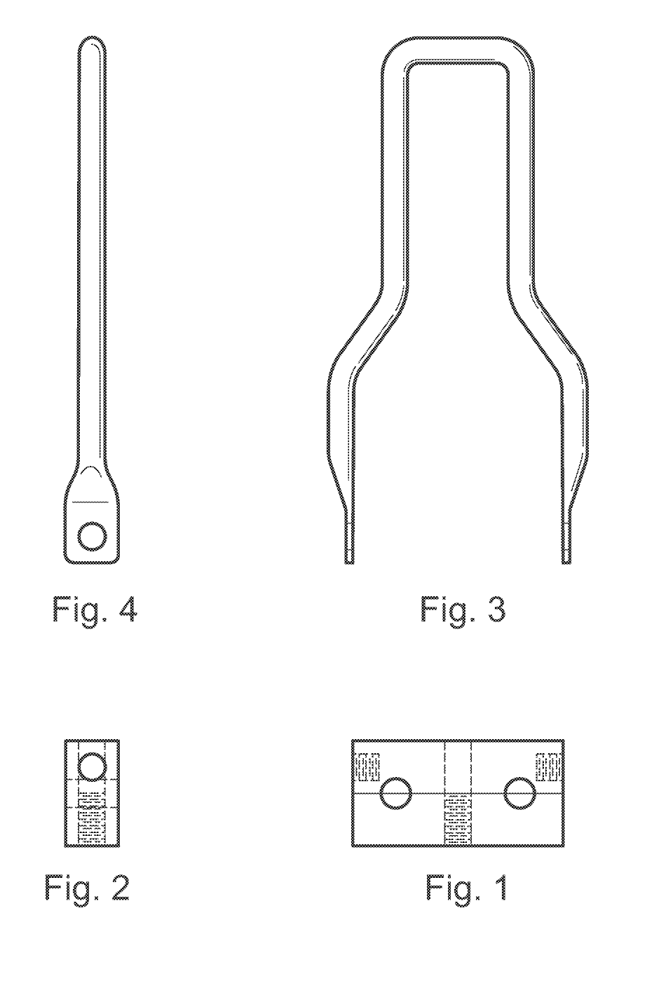

### DETAILED DESCRIPTION

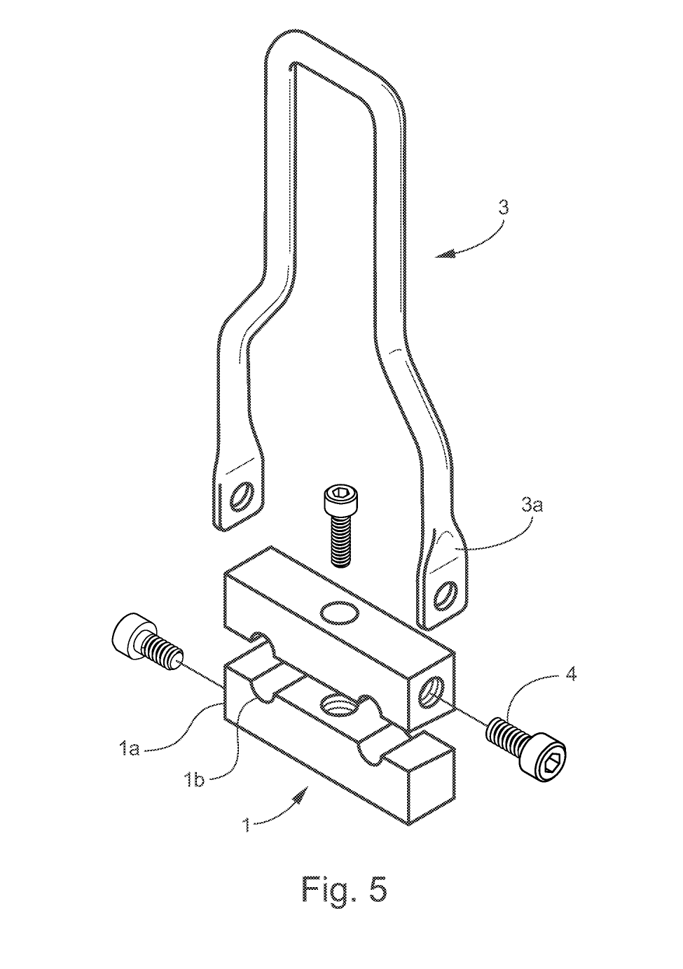

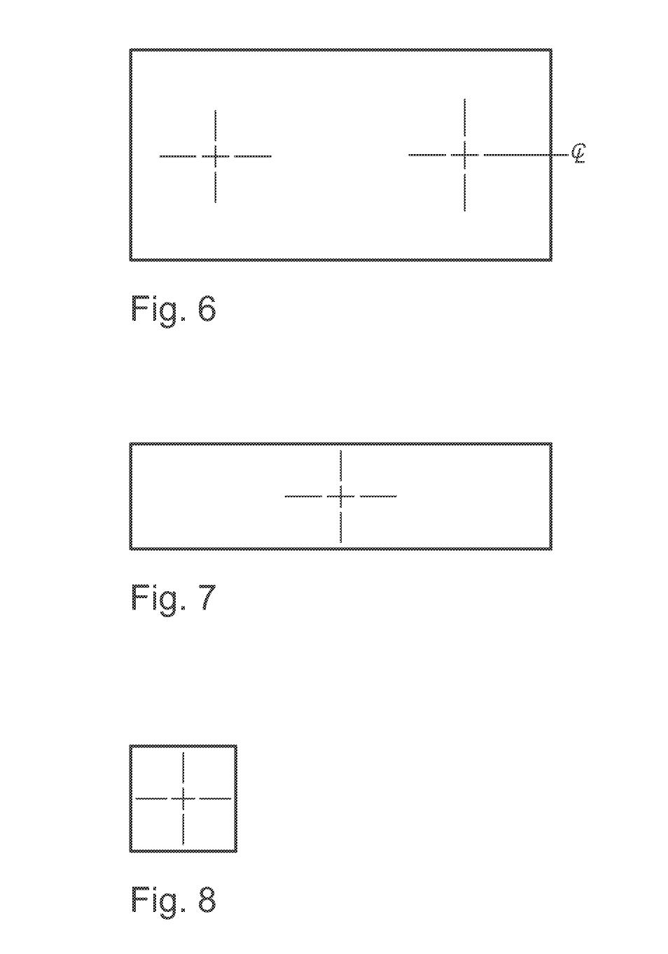

Viewing the drawing as illustrated in FIG. 5, the rear lift gate window ventilation swing arm assembly generally including the mounting brackets 1, secure onto the factory strike loop by a threaded stud 2, a generally “U” shaped member having a square bow end and a pair of opposed parallel legs 3, each of the said leg ends is formed to a flat rectangular flange 3a, having a bore to receive a bolt 4.

The width of the bow end of the “U” shaped member is formed similar in dimension to most vehicles' original rear window strike loop, each of the said leg ends is widened at the mid-section toward the free ends, to allow fitting to the mounting brackets 1, and the “U” shaped member is pivotally mounted to the top bracket 1a, by two threaded bolts 4.

The “U” shaped member serves as an extension to the original strike loop found in the rear swing out window on most wagon type or sport utility vehicle, domestic or foreign. The “U” shaped member can be manufactured using various types of steel, metal, iron, alloys, or aluminum alloys. The “U” shaped member can be formed using different methods such as stamping, pressing, casting, extruding or bending.

The mounting brackets can be manufactured using various types of steel, metal, iron, alloys, or aluminum alloys. The mounting brackets can be formed using different methods such as machining, milling, extruding, or casting.

The bracket comprises of two halves 1, 1a. One bore is provided vertically through the center of the upper bracket 1a and the lower bracket 1, said bore in the lower bracket 1 is internally threaded to receive a bolt 2.

The upper bracket 1a is provided with bore in both ends, said bores are internally threaded to each receive a bolt 4, whereby bolt 4 to be slid through the flanged ends of the “U” shaped member.

The upper and lower bracket when assembled together to provide with two bores 1b along the parting axial line, said bores are provided to accommodate fitting over the parallel legs on the original factory strike loop.

We claim:

1. The rear lift gate window ventilation swing arm assembly comprising an “U” shaped metal rod and a rectangular metal base. The said “U” shaped metal rod provided with two 90 degree bends forming a loop on one end, said “U” shaped metal rod provided with two arms extending from said loop, and having two adjacent and equally spaced arms, said free ends of the two arms being shaped to a rectangular flange to provide two aligned bores, whereby two bolts may be slid through said bores, entering initially through the bore in one of said arms, a bolt designed to be inserted into said bores, and the swing arm to be attached to a metal base, said swing arm being rotatable therein about the metal base' longitudinal axis

2. A device as claimed in claim 1 comprising the metal base as the mounting brackets, said brackets are made of metal, comprising two equal pieces of same dimensions, said one bracket's two ends to provide aligned bores, said bores having internal threads, whereby a bolt may be threaded into said bores, entering initially through the bores in a device as claimed in claim 1,

3. A device as claimed in claim 2 wherein said brackets to provide one central vertical aligned bore, whereby the bracket provided the bore ends with internal threads as claimed in claim 2 to provide a bolt to pass through,

4. A device as claimed in claim 2 wherein said bracket without threaded ends to provide the central bore with internal threads, whereby a bolt through device as claimed in claim 3, may be threaded into said bore,

5. A device as claimed in claim 2 wherein said brackets to provide two bores spaced along the center longitudinal axis, said bores designed to affix over intended attachment,

6. A device as claimed in claim 2 wherein said bores as claimed in claim 4, is dimensioned relative to factory designed rear window strike loop to allow installation of the bracket around said factory loop,

7. A device as claimed in claim 1 comprising an extent of metal shaped to form 2 90 degree bends and provided with two arms extending from said bends and having adjacent free ends; spaced to allow the free ends to be coupled to said bracket as claimed in claim 3,

8. A device as claimed in claim 2 wherein said bracket as claimed in claim 4 said bores being dimensioned to elongate bores axially so the bracket may further be utilized on vehicles of domestic and foreign make, said width of factory rear window strike loop may differ in width.

9. A device as claimed in claim 1 wherein said free legs of device may be manufactured of different length, said length being dimensioned to accommodate various width of window opening per customer's request and need

10. A device as claimed in claim 1 wherein said device may have different surface finish, said finish may be milled, sand blasted, anodized, polished, nickel plated, color painted, chromed, rubber coated, powder coated, brushed and in stainless steel,

11. A device as claimed in claim 2 wherein said device may have different surface finish, said finish may be milled, sand blasted, anodized, polished, nickel plated, color painted, chromed, rubber coated, powder coated, brushed and in stainless steel,

12. A method of manufacturing the device as defined in claim 1, wherein the process to produce the “U” shaped device to include stamping, extruding, casting or bending,

13. A method of manufacturing the device as defined in claim 1, wherein the raw material used to produce the “U” shaped device to include copper, iron, aluminum 6063/60611600516060 T5 or T6.

14. A method of manufacturing the device as defined in claim 1, whereby the brackets as defined in claim 2, wherein the process to produce the rectangular metal base to include machining, casting, extruding or stamping.

15. A method of manufacturing the device as defined in claim 1, wherein the raw material used to produce the rectangular metal base to include copper, iron, aluminum 6063/6061/6005/6060 T5 or T6.
